(19) United States
(12) Patent Application Publication
(10) Pub. No.: US 2010/0234981 A1
(43) Pub. Date: Sep. 16, 2010

(54) TIME CAPSULE SAFEKEEPING SYSTEM

(76) Inventor: John C. Turner, Putney (AU)

Correspondence Address: BRIAN C. TRASK, 3601 EAST HERMES DRIVE, SALT LAKE CITY, UT, 84124, US

(21) Appl. No.: 12/708,554

(22) Filed: Feb. 19, 2010

Related U.S. Application Data
(63) Continuation-in-part of application No. PCT/AU2008/001246, filed on Aug. 22, 2008.

(30) Foreign Application Priority Data
Aug. 22, 2007 (AU) 2007904506

(51) Int. Cl. G06F 7/00

(52) U.S. Cl. 700/215

(57) ABSTRACT

The disclosed time capsule safekeeping system comprises a controlling organisation maintaining a secure registry system of data records relating to a plurality of physical time capsules and a secure storage system for a plurality of physical time capsules. Each physical time capsule is proactively assigned by the controlling organisation a unique identifying code and an at least one identifying device that facilitates access to the data record within an interactive computer based database and additionally prima facie proves ownership of the time capsule. The time capsules are stored within uniquely numbered crypts at the storage facility. Family crypts allow for the storage of a plurality of time capsules comprising a family group. Such a storage system allows for the use of lower cost mass produced time capsule components. The controlling organisation is of a form that gives confidence to the general public in its long term stability and longevity.

### CROSS-REFERENCE TO RELATED APPLICATIONS

This application is a continuation-in-part of PCT International Patent Application No. PCT/AU2008/001246, filed on 22 Aug. 2008, designating the United States of America, and initially published in English as PCT International Publication No. WO 2009/023938 on 22 Feb. 2009, and republished on 16 Apr. 2009, and claims priority to Australian Provisional Application No. 2007904506, filed 22 Aug. 2007, the contents of the entirety of which are all incorporated by this reference.

### BACKGROUND

The present invention relates to the indexing, recording, supply and secure storage of time capsules so as to promote their use by the general public.

Wikipedia defines a time capsule is an historic cache of goods and/or information, usually intended as a method of communication with people in the future.

Time capsules are a convenient and valuable method of passing objects and information through time that otherwise cannot be done.

Time capsules have been used for thousands of years. In general the earlier time capsules can be categorised as unintentional in that they were created perhaps by some random act of nature or were built purposely but not with the intention of opening in the future such as a burial chamber. Conversely, intentional time capsules are intended to be opened in the future and have gained some popularity over the last two hundred years generally as a long term means of marking some particularly important event or celebration.

Historically, intentional time capsules have generally been put together by public bodies (see definition following), then placed in inaccessible and permanent locations such as within a public building foundation and often marked with a plaque or similar permanent record for the future. Not withstanding the seeming permanence of such an arrangement it appears that many such intentional time capsules go missing or are otherwise forgotten about. The International Time Capsule Society headquartered at Oglethorpe University in Atlanta, Ga., USA estimates that there are around 10,000 time capsules worldwide, most of them lost (ITCS website information—27 Jun. 2007). In addition, because time capsules are generally put together by public organisations there is little opportunity for individual members or families of the general public (see definition following) to contribute objects or information to be included in the time capsule.

A further characteristic of the time capsule as it is generally used today is that they are generally intended to be sealed for periods of around 50 years or greater. This is probably because most time capsules are organised and put together by public bodies to mark some special event and are meant to be opened by at least one generation in the future. Any lesser period would hardly warrant the effort on the part of a public body. There are however many occasions when the use of a time capsule over a much shorter period would be useful but for the lack of an easily accessible safekeeping system. Additionally the high cost of manufacturing time capsules with sufficient robustness and corrosion resistance limits their use.

The widespread use of the internet has provided a mechanism for the storage and retrieval of information. U.S. Pat. No. 6,760,731 provides for “a worldwide genealogy data storage and retrieval system for implementation on the internet” that inter alia provides for public subscribers to be able store computer files in the nature of a virtual time capsule. A similar “virtual time capsule” system is described in publication KR20020082304 (31 Oct. 2001) wherein the user gains access to a database held on a server using a password security system. The user is able to store files on the database.

A similar database system but with respect to the registration of mementos from a wedding or the like that a user wishes to keep is described in publication JP 09-301442 (25 Nov. 1997).

A physical time capsule registry is run by The International Time Capsule Society wherein the general public are invited to register existing time capsules with them however the registry system is a reactive system wherein the records are compiled and registered after the time capsule has been put together and appears to be more of an attempt to gather data on existing time capsules than a proactive system where the registration of data relating to time capsules occurs prior to or simultaneous to the putting together of the time capsule. In addition the database is not accessible by the general public.

There is as yet no easily accessed and convenient mechanism for the recording and storage of physical time capsules.

There are clear impediments to the widespread use of time capsules by the general public at large. They are:
The difficulty of providing guaranteed security of storage for the time capsule.
The difficulty of ensuring the time capsule protects the contents adequately
The difficulty of ensuring parties with an interest in the time capsule and/or their successors maintain an awareness of the time capsule.
The expense of specifically manufacturing a suitable container to be used as a time capsule.
The low level of confidence that one would have that the time capsule would be opened by those people intended.
The relative rarity of time capsules and the prevailing understanding that they are generally in the domain of the public body means that individual members and families of the general public would seldom consider putting one together.

Any time capsule safekeeping system that is to enjoy the widespread use by and confidence of the public must address the above impediments but in particular it must provide a secure storage system, must have an accessible database and must have a mechanism to ensure awareness of the time capsule is maintained.

It is an object of the present invention to address or ameliorate the above disadvantages and limitations and to provide the general public with easy access to a time capsule safekeeping system that can be used in whole or in part as it may suit them or at least provide the general public with a useful choice. It is a further object of this invention to promote the widespread and common use of time capsules by the general public.

Note: The term “comprising” (and grammatical variations thereof) is used in this specification in the inclusive sense of “having” or “including” and not in the exclusive sense of “consisting only of”.

### DEFINITIONS

Within this speciation the following terms have the meanings as given under the term. The definitions apply equally to the plural as to the singular.

Associated Party: By associated party we mean any unique member or entity of the general public (as defined herein) that has an association with any time capsule and is identified in the data record for that time capsule. The owning party and opening party are particular associated parties.

Burial Period: By burial period we mean the period of time that the time capsule is to remain sealed before being opened. It will in general be a period of years.

Compact Electronic Record: By compact electronic record we mean any device designed to store information to be read electronically and small enough to fit within the time capsule. For example a laser disc such as a CD or DVD or solid state memory device.

Computer: By computer we mean any electronic device capable of storing and/or passing and/or displaying digital data.

Controlling Organisation: By controlling organisation we mean the organisation responsible for the prudent management of the time capsule safekeeping system including any person or organisation with delegated responsibility for managing aspects of the system.

Crypt: By crypt we mean a cavity, preferably within a solid object or array and preferably with a removable cover, designed to accept a time capsule or plurality of time capsules for storage.

Crypt Identifier: By crypt identifier (CI) we mean an alphanumeric string that is unique to a particular crypt and provides the means to identify within which crypt a particular time capsule is buried. The crypt identifier is permanently marked adjacent to the crypt.

Crypt Module Identifier: By crypt module identifier we mean an alphanumeric string that is unique to a particular crypt module and provides the means to identify a particular crypt module within a plurality of crypt modules. The crypt identifiers of all the crypts within a particular crypt module are indexed to the crypt module identifier of the said crypt module. The crypt module identifier is permanently marked in at least one position on the said crypt module.

Database: By database we mean an integrated collection of data records pertaining to time capsules wherein the data from all data records can be sorted and searched by any data field such as is possible in a typical relational database.

Data Field: By data field we mean one particular area of the data base allocated for a particular category of data common to all data records. For example a name.

Data Record: By data record we mean one group of data in separate data fields (as defined herein) related to one time capsule.

Electronic Identifying Device: By electronic identifying device we mean any device utilising electronic circuitry of any type or form that can be used to generate at least a predefined identifying code when activated.

Family Crypt: By family crypt we mean a cavity preferably within a solid object or array designed to accept a plurality of time capsules from a family group of time capsules for storage. Alternatively a family crypt can mean a collective plurality of crypts containing time capsules from a family group of time capsules for storage.

Family Crypt Identifier: By family crypt identifier (FCI) we mean an alphanumeric string that is unique to a particular family group of time capsules in storage and provides the means to identify which crypts contain or are reserved for time capsules of the said family group of time capsules. The family crypt identifier is permanently marked adjacent to the said crypt or crypts.

Family Group: By family group we mean a group of members of the general public who have or intend to register time capsules with the controlling organisation and desire that those registrations be associated as a related group. The time capsules of that family group form a family group of time capsules.

Family Group Identifier: By family group identifier (FGI) we mean an alphanumeric string that is unique to a particular family group. The family group identifier may or may not be digital.

Family Member: By family member we mean a particular member of the general public who is a member of a family group.

General Public: By general public we mean the public in the widest possible sense including all formal or informal public, private, government related and corporate bodies and organisations as well as individuals.

Identifying Device: By identifying device we mean any device that has unique identifying data relating to a time capsule recorded within or on the device or has a unique code recorded within or on the device that in turn provides access to the said unique identifying data. Such a device can prima facie prove ownership of the time capsule.

Inert Fluid: By inert fluid we mean any gas or liquid that will not have a detrimental effect on the contents of a time capsule.

Interment Date: By interment date we mean the date that a sealed time capsule is placed into its place of safekeeping.

Owning Party: By owning party we mean the person or organisation representing the owners of the time capsule and having the responsibility for filling the time capsule and having it sealed and stored. The owning party may change during the burial period. The owning party is the point of contact with respect to a particular time capsule for the Controlling Organisation.

Pass-key: By pass-key we mean an alphanumeric string or password or personal identification number (PIN) or biometric challenge or any other unique identifying device known by the controlling organisation and at least the owning party (as defined herein) to a particular time capsule and used by at least the owning party to prove their authenticity to the controlling organisation.

Proactive Registration: By proactive registration we mean the registration of a time capsule within a registration system done as an integral part of the process of putting together and sealing of a time capsule as opposed to the mere registration of an existing time capsule.

Public Bodies: By public bodies we mean public sector entities or legal entities governed by private law with a public service mission.

Retrieval Date: By retrieval date we mean the date at the end of the burial period when the time capsule is retrieved from its storage to be opened.

Sealing a Time Capsule: By sealing a time capsule we mean the act of securely closing it prior to its burial after the contents have been placed within it.

Time Capsule: By time capsule we mean a closed and sealed physical container containing goods intended to be left for a specific length of time before being purposely opened. The goods can be anything that fits within the container and not subject to degradation however it is not intended that the time capsules be used as a means of safekeeping wills or high value items for which there are existing safekeeping systems. Within this specification the term time capsule can also include vacant time capsule where the reference is equally applicable to vacant time capsules and filled time capsules.

Time Capsule Opening Party: By time capsule opening party we mean the entity that has been nominated by the time capsule owning party as being responsible for the opening of the time capsule at the end of the burial period. By way of non limiting example it may be a person or organisation or officeholder within an organisation.

Tracking Data: By tracking data we mean data specifically chosen to assist the controlling organisation to keep the data record of a particular time capsule up-to-date. By way of non limiting example it would include data such as addresses and/or relationships to owning party.

Unique Identifying Code: By unique identifying code (UIC) we mean an alphanumeric string that is unique to a particular time capsule. The UIC may or may not be digital. Unique identifying code may be abbreviated to UIC within this specification.

Vacant Time Capsule: By vacant time capsule we mean a physical container designed to store and protect goods undisturbed for an extended period of time but presently empty and unsealed.

### SUMMARY OF THE INVENTION

In a broad form of the invention there is a time capsule safekeeping system available for use by the general public (as defined herein) through a controlling organisation comprising in combination:

(a) an at least one centralised storage facility for a plurality of physical time capsules and
(b) a secure registry system for the recording and indexing of data records (as defined herein) related to said plurality of physical time capsules and
(c) an at least one type of identifying device supplied by the controlling organisation to at least the owning party or an associated party that at least provides a means of accessing the data record for said time capsule and prima facie proves ownership of the time capsule and wherein
(i) said time capsules are physically stored in an indexed and recorded location by said controlling organisation in said at least one centralised storage facility such that they are provided with protection from common threats,
(ii) each said time capsule is proactively assigned a UIC by said controlling organisation and wherein said UIC is recorded on, in or with said time capsule,
(iii) the component data records of the database within said registry system includes, for each time capsule, data of at least said UIC and of the owning party of the time capsule together with additional data pertaining to each time capsule,
and wherein the database of said registry system is accessible by at least the owning party.

Preferably said time capsules are supplied by said controlling organisation as vacant time capsules to be filled and stored.

Preferably said supplied vacant time capsules are supplied with said UIC engraved or otherwise indelibly marked on at least one of the components of said vacant time capsule.

Preferably said supplied vacant time capsules are modular in form and wherein the components of said time capsules can be lower cost, mass produced standard components such as injection moulded plastic components and wherein said components are locked together on assembly such that time capsules of many varying dimensions can be made from a few standard components that securely fit together to form a totally gas and liquid tight container after assembly and closure and wherein the assembled time capsules are of dimensions compatible with said storage system.

Preferably said time capsule incorporates a fitting to facilitate the evacuation of air and/or the replacement of that air by a suitable inert fluid within said time capsule and the subsequent sealing of said time capsule, said fitting consisting of a captured elastomeric ring or plug designed to pass a sharp, smooth and hollow needle into the enclosure of said time capsule through which said evacuation and/or the replacement of the air can be effected such that said ring or plug seals as the needle is withdrawn and wherein an additional sealing device is fitted in place over the top of said elastomeric ring or plug after said evacuation and/or the replacement of the air has been effected such as a sealed plug screwed in place.

Preferably said vacant time capsules are supplied with packaging items designed to assist with the maintenance of an optimum storage environment within the time capsule such as porous sachets or capsules containing substances (such as silica gel) that adsorb or absorb gases that are likely to have a deleterious effect on the contents of the time capsule; neutral pH paper for interleaving of photographs and cushioning items for fragile articles.

Preferably said controlling organisation supplies or facilitates the supply of various memento type items to be stored within said vacant time capsules.

Preferably said various memento type items include any of the following:

(i) bottles of alcoholic liquor such as wine,
(ii) clockwork powered audio storage and playing devices such as MP3 players,
(iii) clockwork powered video storage and playing devices such as MP4 players,
(iv) newspapers and similar publications,
(v) digitally stored media content such as television programs and particularly news broadcasts.

Preferably said time capsules are provided with a tamper evident physical seal that must be broken before said time capsule can be opened, said seal being coded electronically and/or visually such that it is uniquely identified with a particular time capsule.

Preferably said tamper evident seals also act as identifying devices providing identifying data for the time capsule and/or access to the database of the registry system.

Preferably said data records of said database of said registry system can be searched and sorted by any data field.

Preferably said data record for each said time capsule includes any one of, or combination of, or all of the following data fields in addition to said UIC associated with each said time capsule:

(i) identification of the owning party of said time capsule at the time of burial,
(ii) tracking data for said time capsule owning party,
(iii) identification of the opening party of said time capsule at the time of burial,
(iv) tracking data for said time capsule opening party,
(v) the physical address for service of documents and communications,
(vi) the electronic address of owning party,
(vii) the burial period of the time capsule,
(viii) the interment date of the time capsule,
(ix) the retrieval date of the time capsule,
(x) the family group identifier,
(xi) the location of said time capsule at the time of said burial,
(xii) the contents of said time capsule,
(xiii) identification of any associated parties of said time capsule at the time of burial,
(xiv) tracking data for said time capsule associated parties,
(xv) instructions to said time capsule opening party,
(xvi) a visual image (digital or otherwise) of the contents of the time capsule at the time that it was filled and sealed,
(xvii) the crypt identifier if applicable.

Preferably said registry system allows a plurality of data records relating to a plurality of physical time capsules to be grouped as a family group.

Preferably said registry system is a computer based, interactive system configured for use with the internet.

Preferably at least the owning party can attain access to the data records including family groups of data records pertaining to their time capsules after satisfying security requirements by means of a pass-key issued by said controlling organisation and wherein alterations, deletions and additions to certain of said data fields of said data records can be made in order to maintain the currency and accuracy of the data held within said data records.

Preferably a copy or a plurality of copies of the data record, preferably as a compact electronic record, relating to a time capsule at the time of burial is/are enclosed within said time capsule.

Preferably said secure storage facility provides for the storage of said time capsules within an at least one crypt, said crypts providing protection for said time capsules such that the time capsules themselves need not be manufactured to be as robust as would otherwise be the case.

Preferably said crypts are specifically sized to accept modular time capsules or a plurality of modular time capsules supplied by the controlling organisation.

Preferably each said crypt has assigned to it a unique crypt identifier.

Preferably an at least one said crypt or plurality of crypts comprises a family crypt that provides for the burial of a family group of time capsules and wherein said family crypt has assigned to it a unique family crypt identifier.

Preferably said family crypt provides for each family member time capsule of said family group of time capsules to be buried and retrieved from burial at different times.

Preferably each said crypt comprises a cavity within a crypt module containing a plurality of such said cavities and wherein each said cavity is provided with a removable access cover such that when said access cover is fixed in place said cavity becomes totally enclosed and preferably sealed against ingress of liquid or gas.

Preferably said crypt module is formed by means of casting a binding and protective substance around a plurality of solid tubes such that the resulting said crypt module is a self contained solid block-like object containing a plurality of crypts that provides protection for the component crypts.

Preferably said crypts are easily removed and replaced from said crypt module for the purposes of adding or retrieving time capsules.

Preferably said crypt module is constructed with inbuilt features that facilitate the fixing of a plurality of said crypt modules together such that they lock together in both the horizontal and vertical planes to form a solid and robust assembly.

Preferably said assembly of crypt modules can be moved such that a plurality of such assemblies can be compressed up against one another to form a solid block-like structure in order to maximise the crypt storage capacity whilst offering superior protection to the component crypts.

Preferably said crypts are formed as an array of vertical cavities such as pipes designed to store time capsules in a vertical stack.

Preferably said vertical cavities are buried partially or fully beneath ground level.

Preferably said controlling organisation or representative thereof inspects the time capsule and its contents by visual or penetrative means such as X-ray to assist in ensuring no prohibited substances or items are included.

Preferably said identifying device takes the form of an engraved plaque or similarly permanently marked device that is easily recognised and not easily mislaid or discarded.

Preferably said identifying device has a machine readable code on it such as a one or two dimensional bar code or takes the form of or has within it an electronic identifying device as defined herein.

Preferably automated access to the corresponding data record within the registry system database is provided when said identifying device is scanned.

Preferably said controlling organisation provides at least said owning party with a plurality of said identifying devices of differing types.

Preferably said controlling organisation is a trust.

Preferably the trustee of said trust is a corporate body.

Preferably said controlling organisation has a significant representation from a parcel delivery organisation such as a postal or courier service.

Preferably said controlling organisation has representation from a public body as defined herein with a reputation for long term stability such as “The Public Trustee”.

Preferably the controlling organisation licenses agents to promote and manage the commercial activities of the controlling organisation in an at least one particular geographical area and/or commercial sector.

In a further form of the invention there is a method for the safekeeping of time capsules administered by a controlling organisation; said method including the step of proactively assigning a UIC to said time capsule and providing an identifying device for said time capsule and accepting for secure storage the time capsule and its contents and providing secure storage on behalf of the owner of said time capsule in a protected environment such as within a crypt herein described for the burial period of said time capsule and further including any of or combination of the following steps:

(a) recording data pertaining to said time capsule in a registry system,
(b) allowing limited access to the registry system by the general public,
(c) allowing complete access to data records pertaining to specific time capsules by the owning party or associated entities by means of a pass-key issued by said controlling organisation,
(d) supplying vacant time capsules from a standard range of said vacant time capsules to the owning party,
(e) supplying an at least one identifying device to the owning party,
(f) inspecting the time capsule and its contents by visual or penetrative means such as X ray,
(g) advising the owning party and/or associated parties when a time capsule is approaching the end of its burial period.

### BRIEF DESCRIPTION OF THE FIGURES

Embodiments of the present invention will now be described with reference to the accompanying drawings wherein:

FIGS. 1, 2 and 3 are schematic representations of 3 broad forms of a time capsule safekeeping system wherein: the arrowed solid lines represent the flow of items in the direction indicated, the arrowed dotted lines represent the flow of data in the direction indicated and the double solid hatched lines represent a relationship between the entities at each end of the lines.

FIG. 4 is a schematic representation of a time capsule storage system wherein the arrowed lines represent the flow of items in the direction indicated.

FIG. 4A is an enlargement of a corner of a crypt module shown in FIG. 4.

FIG. 5 is a lid for a preferred form of time capsule (shown in FIG. 4) incorporating a fitting (shown schematically) to facilitate the evacuation and or replacement of the air within the time capsule.

FIGS. 5A and 5B are sectioned views of the fitting shown in FIG. 5.

FIG. 6 is an isometric view of a modular, cylindrical time capsule with tamper evident seals between adjacent components.

FIG. 7 is a printed version of an example data record for a time capsule.

FIG. 8 is a sectioned view of a crypt formed within a solid crypt module.

FIGS. 9A, 9B and 9C illustrate a preferred form of time capsule storage and crypt arrangement.

### DETAILED DESCRIPTION OF THE PREFERRED EMBODIMENTS

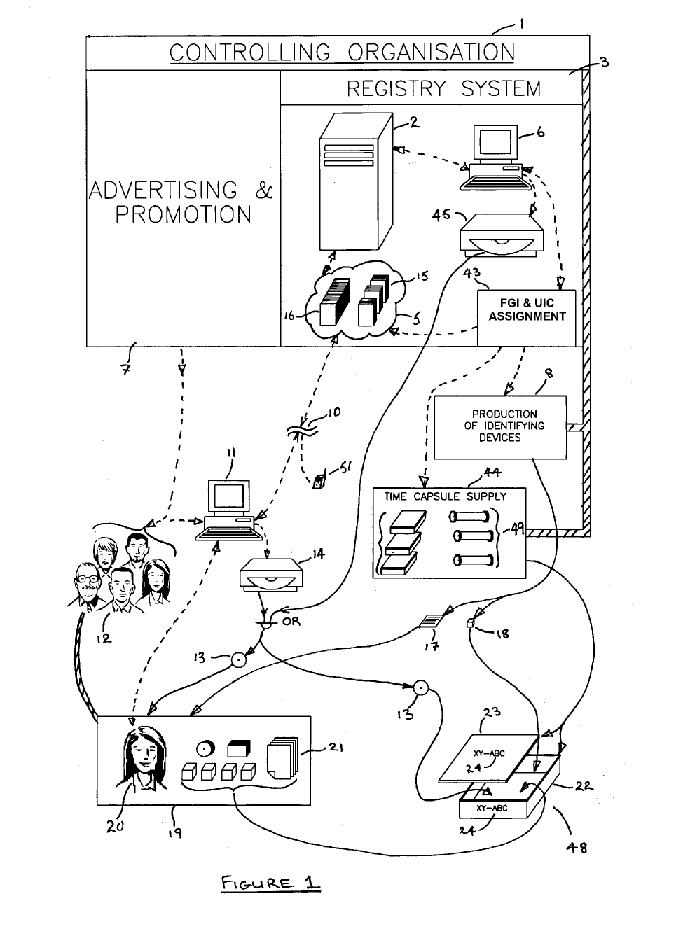

With reference to FIG. 1 there is shown schematically a time capsule safekeeping system including a registry system 3 available for use by the general public 12 through a controlling organisation 1. The controlling organisation 1 advertises and promotes the system 7 (as one of its functions) to the general public 12. By this means the widespread and common use of time capsules by the general public 12 is encouraged.

The controlling organisation 1 runs a registry system 3 having a data storage device 2 for the recording and indexing of data records 5 relating to a plurality of time capsules. Preferably the data storage device 2 is an electronic system. More preferably the data storage device 2 is a computer system with internal access provided by means of computer terminal 6.

Preferably the data records 5 contain a plurality of individual data records 16i-n (where there are n individual data records 16i) relating to individual time capsules as well as a plurality of family groups of data records 15 relating to family groups of time capsules. Each data record within said family group of data records would share a common family group identifier assigned by the controlling organisation and preferably by the same entity assigning the UICs.

The data records 5 contained within the registry system 2 can be accessed by the general public 12 to a limited extent. Preferably said access is provided by means of any computer 11 or similar device such as a mobile phone 51 connected to the internet 10. Members of the general public who are associated parties, one of which is depicted as 20, can access complete data records relating to their time capsules by means of a pass-key issued by the controlling organisation 1 and preferably using any computer 11 connected to the internet 10. Preferably the general public 12 would have read-only access to a listing of UICs and limited data pertaining to the time capsules only whereas the owning party and possibly associated parties would have read access to their complete data records including family groups of data records and write access to certain of the data fields within the said data records for the purposes of maintaining the currency and accuracy of the data held within the said data records.

Preferably the database is a typical relational database such that data records can be searched and sorted by any data field. By way of non limiting example the database could be searched for all instances of a particular entity of the general public such that all time capsules associated with that entity would be identified.

With further reference to FIG. 1 the general public member 20 being desirous of putting together a time capsule 48 has certain items 21 that will be the contents of the said time capsule. Contact is made with the controlling organisation 1 preferably through the medium of the internet 10 by using a computer 11 or similar device with internet connectivity such as a mobile phone 51. The time capsule is registered and a UIC is assigned by a UIC assignment entity 43, an integral part of the controlling organisation 1. Said general public member 20 may or may not wish to have the time capsule 48 registered as part of a new or existing family group. The said member of the general public 20 is now the owning party and a data record 16i for the time capsule is built up. Preferably said data record 16i contains all relevant data pertaining to the time capsule including by way of non limiting example, any one of or combination of the following data fields in addition to the UIC:

(i) identification of the owning party of the said time capsule at the time of burial,
(ii) tracking data for the said time capsule owning party,
(iii) identification of the opening party of the said time capsule at the time of burial,
(iv) tracking data for the said time capsule opening party,
(v) the physical address for service of documents and communications,
(vi) the electronic address of owning party,
(vii) the burial period of the time capsule,
(viii) the interment date of the time capsule,
(ix) the retrieval date of the time capsule,
(x) the family group identifier,
(xi) the location of the said time capsule at the time of said burial,
(xii) the contents of the said time capsule,
(xiii) identification of any associated parties of the said time capsule at the time of burial,
(xiv) tracking data for the said time capsule associated parties,
(xv) instructions to the said time capsule opening party,
(xvi) a visual image (digital or otherwise) of the contents of the time capsule at the time that it was filled and sealed,
(xvii) the crypt identifier if applicable,
(xviii) the family crypt identifier if applicable.

Should the time capsule be registered as part of a family group then the data record pertaining to the time capsule 48 will be indexed as a component of a family group 15.

Preferably a copy of the data record 16i relating to a particular time capsule 48 is enclosed within the said time capsule 48 at the time that the said time capsule is filled and stored. This is explained in more detail below.

Turning now to FIG. 7 and by way of illustration there is shown a typical printed version of a data record 71 for a time capsule with assigned UIC of AB-XYZ-999. The names of the data fields are shown in bold type and the data within each field is in regular type. All the data shown within each data field is illustrative only.

With reference now to FIGS. 1, 2 and 3 preferably the controlling organisation will supply the vacant time capsule 48 from a supply system 44 under the control of the controlling organisation 1 to the owning party 20 for the owning party to fill. Preferably at least one and more preferably all of the individual components of the time capsule 48 will be supplied with the UIC 24 engraved or otherwise indelibly marked on them. In FIGS. 1, 2 and 3 a rectangular time capsule is shown consisting of a body 22 and a lid 23, both of which have the UIC marked on them.

Preferably the components of the vacant time capsule 22, 23 are selected by the controlling organisation 1 within the time capsule supply system 44 from a standard range of capsules 49 of different dimensions and materials. Clearly the dimensions required are a function of the aggregate size of and the nature of the contents 21 to be placed within the time capsule 48 and accordingly the owning party 20 will confirm the choice of a particular vacant time capsule based on their knowledge of the intended contents 21.

Preferably the vacant time capsule 48 will be chosen from time capsules made from a range of different materials (not shown). The material chosen by the owning party 20 would be a function of how and where the time capsule was to be stored however as the invention is intended to promote the widespread use of time capsules by the general public it is preferable to use lower cost materials for the time capsule construction and utilise the storage system 4 as a means of protecting the capsule.

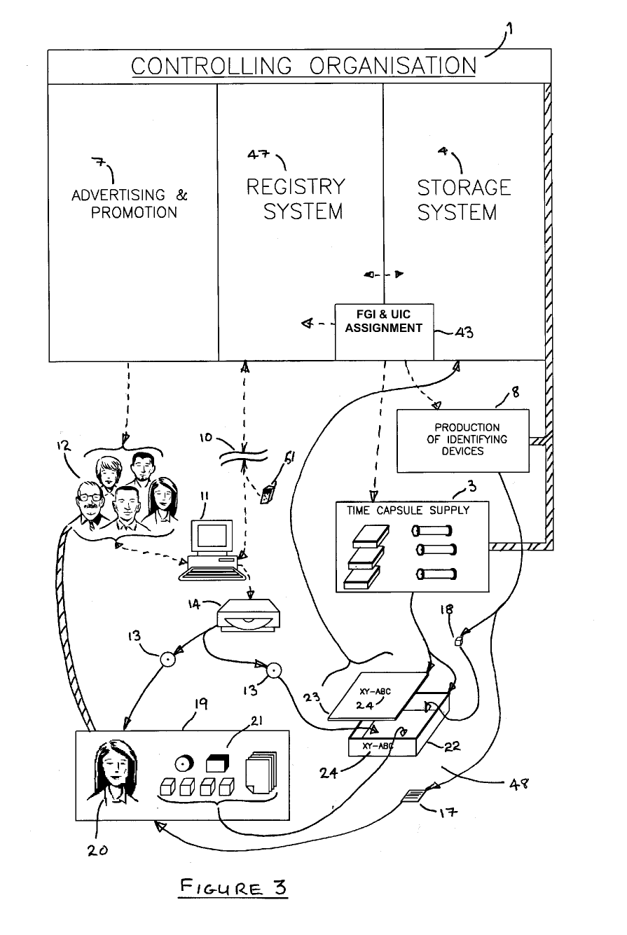

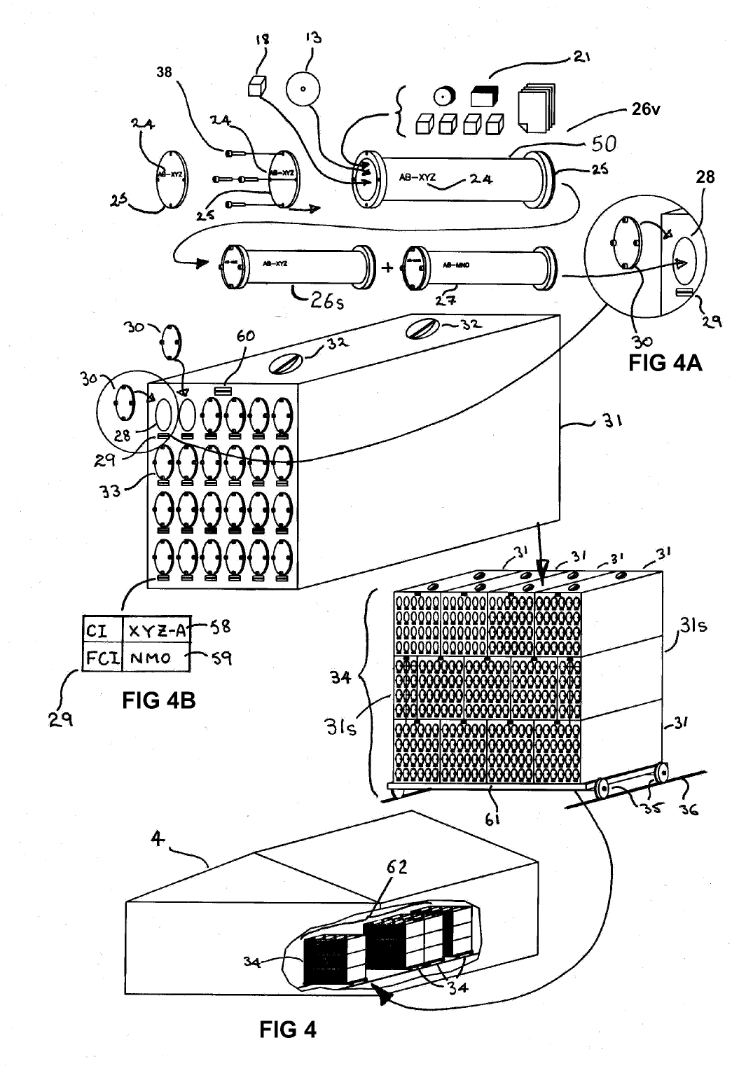

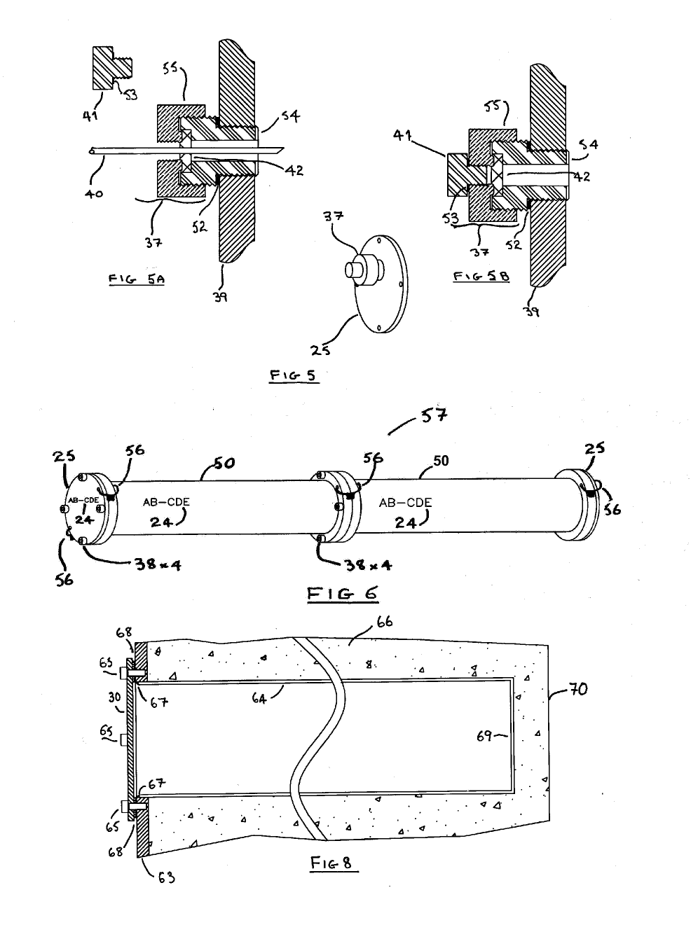

Preferably the vacant time capsule 48 supplied would be modular in form and fabricated from standard components that are locked together on assembly such that time capsules of many varying dimensions can be made from a few standard components that fit securely together. Preferably the components are lower cost mass produced components such as injection moulded plastic components. By way of non limiting example a preferred form of cylindrical tubular time capsule as is shown as 26 and 27 in FIG. 4 could be fabricated from open ended tubes 50 of varying length with end plates 25 secured in place by means of screws 38 or some other means. With reference to FIG. 6 in yet a further preferred form of this embodiment (not shown) 2 open ended tubes 50 are secured together with screws 38 or some other means end to end to form a longer tubular time capsule closed off with end plates 25. Clearly time capsules of different lengths can be made by using different numbers of tubes 50 in the construction.

Turning again now to FIGS. 1 and 3 preferably the controlling organisation 1 will produce and supply identifying devices 17,18 from a production system 8 under the control of the said controlling organisation 1 to the owning party 20 to either retain as a record of the time capsule and/or to place inside or attach to the said time capsule 48 as it is filled. A preferred form of said identifying device is a permanent hard copy of data pertaining to the said time capsule from the said data record 16i. More preferably the said permanent hard copy takes the form of an engraved plaque 17 or similar permanently marked device that is easily recognised and not easily mislaid or discarded by the said owning party 20 or associated parties (not shown). Another preferred form of identifying device is an electronic identifying device 18 such as an RFID chip. Said device can be placed within the said time capsule 48 as it is sealed and can be activated and read at any time during the burial period of the said time capsule 48 from outside of the said time capsule 48. Preferably the said electronic identifying device 18 will generate at least the UIC 24 of the said time capsule 48 when activated and machine read thus allowing the said time capsule 48 to be matched to the corresponding data record 16i within the said registry system. A further preferred form of identifying device is an item with at least one flat surface having a one or two dimensional barcode on the surface (not shown). Said barcode when scanned or machine read provides access to at least identifying data for the time capsule (48) within the database of the registry system (47). More preferably said barcode provides access (after satisfying security constraints) to the data record (5). Thus it is possible for an owning party to scan the said barcode with a scanner such as a mobile phone with scanning capability and be directed through the internet directly to the database of the registry system (47). An advantage of this type of identifying device is that it provides a convenient mechanism to interact directly with the database of the registry system (47) whenever certain fields of the database require updating. Clearly the said barcode could be conveniently displayed on the engraved plaque (17) referred to above in this paragraph. A further preferred form of said identifying device is a compact electronic record. Said compact electronic record 13 is produced by said owning party 20 from a computer peripheral device such as a CD or DVD writer 14 attached to a computer 11 or the like. Alternatively said compact electronic record is produced by the controlling organisation 1 using a peripheral device such as a CD or DVD writer 45 connected to the registry system 2 through computer 6. A complete copy of the said data record 16i can be written to the said compact electronic record 13 and retained by the said owning party 20 and/or the said associated parties (not shown) and/or placed within the said time capsule 48 as it is filled.

In order to ensure knowledge of the existence of any particular time capsule endures over time it is preferable to have a plurality of said identifying devices of differing types distributed amongst the owning party and associated parties of the said time capsule. Another function of the identifying device is to prima facie prove ownership of the time capsule. Whilst it is preferable to have a number of identifying devices both within the time capsule and distributed amongst the owning and associated parties it is more preferable to have only one such device as the one that prima facie proves ownership.

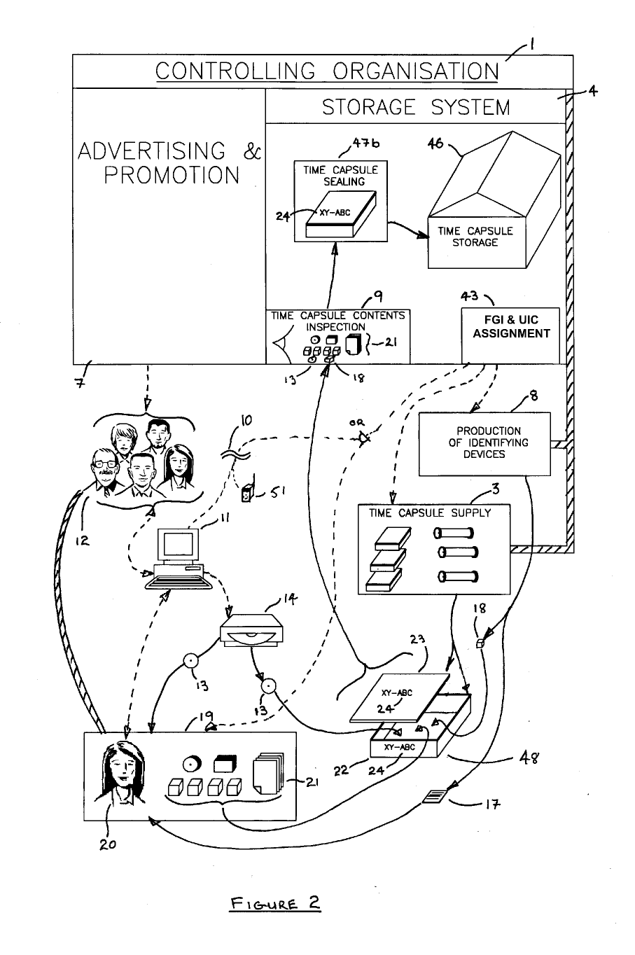

With reference now to FIG. 2 there is shown schematically a time capsule safekeeping system including a storage system 4 available for use by the general public 12 through a controlling organisation 1. The controlling organisation 1 advertises and promotes the system 7 (as one of its functions) to the general public 12. By this means the widespread and common use of time capsules by the general public 12 is encouraged. Where relationships between numbered items in FIG. 2 are identical to those shown in FIG. 1 then the descriptions and explanations pertaining to FIG. 1 as given above apply equally to FIG. 2.

The controlling organisation 1 runs a storage system 4 for the secure storage of time capsules on behalf of owning parties 20. A UIC is assigned by a UIC assignment entity 43 setup within the controlling organisation 1 for the time capsule 48 that is to be filled with contents 21 and submitted to the controlling organisation for secure storage in a purpose built facility 46. Preferably said secure storage facility 46 provides protection for the said time capsule against theft, fire, flood, earthquake or any other common man-made or naturally occurring threat. Said UIC can be communicated to the owning party 20 either directly or through an intermediate medium such as the internet 10.

With continuing reference to FIG. 2 the time capsule 48 and the contents 21 and any identifying devices such as an electronic identifying device 18 to be included and a record of any data pertaining to the time capsule to be included preferably in the form of a compact electronic record 13 are submitted to the controlling organisation prior to sealing of the said time capsule.

Preferably the said time capsule 48 along with all of the contents 21, 13 & 18 as described in the preceding paragraph are inspected by the controlling organisation 1 or representatives thereof at an appropriate facility 9. Said inspection may just be visual but preferably will be by X ray and/or ultrasound or other penetrative means. Indeed in the case where the time capsule is submitted to the controlling organisation already sealed a penetrative means of inspection such as X ray is necessary. Any prohibited substances or items are removed prior to the said time capsule being sealed at an appropriate facility 47b or alternatively if sealed the time capsule is not accepted for storage. Sealed time capsules that pass inspection are then placed in the storage facility 46.

With reference now to FIG. 3 there is shown schematically a time capsule safekeeping system including a registry system 47 and a storage system 4 available for use by the general public 12 through a controlling organisation 1. The controlling organisation 1 advertises and promotes the system 7 (as one of its functions) to the general public 12. By this means the widespread and common use of time capsules by the general public 12 is encouraged. Where relationships between numbered items in FIG. 3 are identical to those shown in FIGS. 1 and/or 2 then the descriptions and explanations pertaining to FIGS. 1 and/or 2 as given above apply equally to FIG. 3. The registry system 47 in FIG. 3 has identical functionality as the registry system 47 in FIG. 1 but in addition liaises with and shares data with the storage system 4 also under the control of the controlling organisation 1. The storage system 4 in FIG. 3 has identical functionality as the storage system 4 in FIG. 2 but in addition liaises with and shares data with the registry system 47 also under the control of the controlling organisation 1.

Still with reference to FIG. 3 the controlling organisation 1 runs a registry system 2 for the recording and indexing of data records relating to a plurality of time capsules and a storage system 4 for the secure storage of time capsules on behalf of owning parties 20. A data record (not shown) for the time capsule 48 is built and stored within the said registry system. A UIC is assigned by a UIC assignment entity 43 setup within the controlling organisation 1 for the said time capsule 48 that is to be filled with contents 21 along with any identifying devices such as an electronic identifying device 18 to be included, and a record of any data pertaining to the time capsule to be included, preferably in the form of a compact electronic record 13. The said time capsule 48 and contents 21, 18 & 13 are submitted to the storage system 4 for inspection (not shown), sealing (not shown) and then storage within a secure facility (not shown).

With reference now to FIGS. 1, 2, 3 and 4 the vacant time capsules supplied have at least one component thereof engraved or otherwise indelibly marked with the UIC 24. Preferably all of the components of the said vacant time capsules are engraved or otherwise indelibly marked with the UIC 24. For example a vacant time capsule (not shown) might consist of n components. Preferably all n components are engraved or otherwise indelibly marked with the UIC 24.

With reference now to FIGS. 1, 2 & 3 in a preferred embodiment of the invention the lid 23 of the time capsule 48 seals against the body 22 of the said time capsule when fitted together such that the said time capsule becomes totally gas and liquid tight when closed. In such an arrangement the time capsule provides superior protection to the contents over extended periods of time. A preferred method of providing the seal is by utilising an elastomeric O-ring or gasket (not shown) between the faces of said lid and said body. A similar sealing arrangement as described above in this paragraph is used between all adjacent components of a modular time capsule such as is illustrated in FIG. 6 wherein the time capsule 57 consists of 2 body portions 50 with end caps 25. An elastomeric O-ring or gasket (not shown) is fitted between the end caps 25 and body portions 50 and between the 2 body portions 50 so as to make the assembled time capsule totally gas and liquid tight when closed.

With reference now to FIG. 5 in a further preferred embodiment of the invention there is fitted to one component of the time capsule a fitting 37 (shown schematically) to facilitate the evacuation of the air from the time capsule after closure, and/or the replacement of the said air by a suitable inert fluid. Turning now to FIG. 5A the fitting 37 is shown in cross section. The base of the fitting 54, with a central hole through it, screws into the wall of the time capsule 39 and a gas tight seal is created between the two by means of a gasket or O-ring 52. In turn, a cap 55 with a central hole through it screws over the base 54 and compresses an elastomeric (preferably silicone rubber) plug 42 between the base 54 and the cap 55. The internal cavity of the time capsule (not shown) is now effectively sealed from the outside. A smooth, sharp, hollow needle 40 is now passed through the said elastomeric plug 42 as is shown in FIG. 5A. Evacuation of the said air from within the time capsule is effected by means of a vacuum pump (not shown) connected to the said needle. Replacement of the said air by an inert fluid can be effected through the same said needle 40 by allowing the said gas or liquid to flow into the evacuated internal cavity of the time capsule. Following the evacuation and/or air replacement the needle 40 is withdrawn and the elastomeric plug closes behind it effectively recreating the gas seal. A plug 41, fitted with gasket or O-ring 53, screws into and seals against the cap 55 as shown in FIG. 5B thereby creating a totally gas tight seal between the said internal cavity and outside of the time capsule. Preferably the fitting is screwed into the lid 25 of the time capsule but its effectiveness is not diminished in any other position on the external walls of the time capsule.

In another preferred embodiment of the invention vacant time capsules supplied by the controlling organisation to owning parties are supplied with a kit of packaging items designed to assist with the maintenance of an optimum storage environment within the time capsule. By way of non limiting example, the contents of said kit could be comprised of porous sachets or capsules or the like containing substances (such as silica gel) that adsorb or absorb gases that are likely to have a deleterious effect on the contents of the time capsule; neutral pH paper for interleaving of photographs and cushioning items for fragile articles.

In another preferred embodiment of the invention the controlling organisation supplies or facilitates the supply of various memento type items to be stored within said vacant time capsules. By way of non limiting example said various memento type items may include any of the following:

(i) bottles of alcoholic liquor such as wine,
(ii) clockwork powered audio storage and playing devices such as MP3 players,
(iii) clockwork powered video storage and playing devices such as MP4 players,
(iv) newspapers and similar publications,
(v) digitally stored media content such as television programs and particularly news broadcasts.

In another preferred embodiment of the invention tamper evident physical seals are provided that must be broken before the time capsule can be opened. The said seals can be of various form and configuration to suit a particular time capsule but are coded electronically and/or visually such that they are uniquely identified with a particular time capsule. Turning now to FIG. 6 as a non limiting example in a particular preferred form of this embodiment a modular time capsule 57 consisting of 2 cylindrical body portions 50 fixed together with screws 38 and 2 end caps 25 each fixed to opposing ends of the body portions with screws 38 (not shown on the right hand end) and with tamper evident seals 56 applied to the 3 interfaces between the 4 separate components of the time capsule. In this instance the tamper evident seals consist of a flexible wire or the like threaded through matching holes in each component with the ends drawn together and joined within a crimped or fused lead block or the like. In this instance 2 seals are required at each interface making 6 in total of which 3 are visible and 1 partly visible in FIG. 6. The said time capsule 57 cannot be opened at any of the said interfaces without breaking at least one of the said seals. In a preferred embodiment said tamper evident seals also act as identifying devices providing identifying data for the time capsule and/or access to the database of the registry system.

With reference now to FIG. 4 there is shown a preferred form of time capsule secure storage facility utilising crypts. The contents of a time capsule 21 preferably along with a compact electronic record 13 of the data record pertaining to the time capsule 26v and an electronic identifying device 18 and gas absorbing or adsorbing porous sachets or capsules or the like (not shown) are placed within the vacant time capsule 26v. The time capsule 26v is closed by means of fixing the end cap 25 to the body 50 by means of screws 38. Preferably tamper evident seals (not shown) are applied to each interface of the time capsule and the air is evacuated and or replaced with an inert fluid (not shown). The sealed time capsule 26s along with another sealed time capsule 27 is placed within a family crypt 28 shown in FIGS. 4 and 4A. Time capsules 26s and 27 are components of a family group. Alternatively (not shown) a sealed time capsule, not part of a family group, is placed within a crypt. Referring now to FIG. 4B the crypt identifier 58 and family crypt identifier 59 if applicable are permanently marked on the tag 29 adjacent to the crypt. By permanently marked we mean a mark that cannot be erased or otherwise removed inadvertently and will not deteriorate over time and will have resistance to fire, flood or other common man made or natural events. Regardless of whether a crypt is a family crypt or a component of a family crypt or not it will have a crypt identifier. Accordingly a family crypt may comprise a number of component crypts that are not necessarily adjacent to each other but are indexed to the parent family crypt identifier.

Turning again now to FIGS. 4 and 4A the crypt or family crypt 28, once filled has a removable cover 30 securely fitted in place. Preferably the said crypt 28 is sealed against ingress of liquid or gas by the said cover. In the case of a family crypt the said cover 30 can be removed at some point in the future for the purpose of adding another family member time capsule to the said family crypt.

In one preferred form of storage system not shown the crypts are cavities formed within a solid masonry or concrete wall or plurality of said walls.

Still with reference to FIG. 4 there is shown a preferred configuration of crypts within a crypt module 31. A plurality of said crypts are fitted within a solid block-like structure forming a regular shaped module. The actual shape and size of the said crypt module and the number of said crypts within the said module can vary and indeed must vary as a function of the size and shape of each component crypt. The said crypt module 31 provides a convenient method of building up a solid and robust assembly of crypts that can be installed within a wide variety of premises without extensive and permanent civil works. The crypt module 31 is fitted with inbuilt features (not shown) that allow for a plurality of said crypt modules to be securely locked together as the said assembly. As there is a requirement for more crypts additional crypt modules can be added to the said assembly. Movement and stacking of the said crypt modules by means of an overhead crane or the like is aided by the addition of two recessed anchor points 32 in the top of each said crypt module. Alternatively or additionally two slots (not shown) can be provided in each said crypt module to receive the tines of a fork truck to assist in the moving and stacking of the said crypt module.

Still with reference to FIG. 4 and in particular the crypt module 31 an at least one identification tag 60 displaying the crypt module identifier is permanently fixed to the crypt module 31 in a position or positions that allow for the said module to be easily identified when stacked as part of an assembly 34 as described below. All the crypt identifiers of the said crypts within the said module are indexed to the crypt module identifier. The said crypt module identifier is permanently marked on the said tag 60. By permanently marked we mean a mark that cannot be erased or otherwise removed inadvertently and will not deteriorate over time and will have resistance to fire, flood or other common man made or natural events.

Still with reference to FIG. 4 there is shown a preferred form of crypt module assembly 34 wherein a plurality of crypt modules are fitted together on a bogey 61. Said bogey is fitted with wheels 35 that run on rails 36. In this instance there are shown four crypt modules 31 side by side on the bottom row with three crypt modules 31 and two ½ width crypt modules 31s forming the second row sitting on top of the bottom row and four crypt modules 31 forming the third and top row sitting on top of the second row such that the modules interlock in the manner of juxtaposed bricks in a brick wall.

This said assembly can be urged along the said rails 36 such that a plurality of assemblies 62 within a storage facility 4 can be moved together and compressed up against each other to form a larger solid block whilst retaining the ability to move the assemblies 34 apart in order to access a particular crypt. By this means the number of crypts for a given floor area can be maximised whilst putting them into a configuration offering superior protection against fire, theft and earthquake or similar threats.

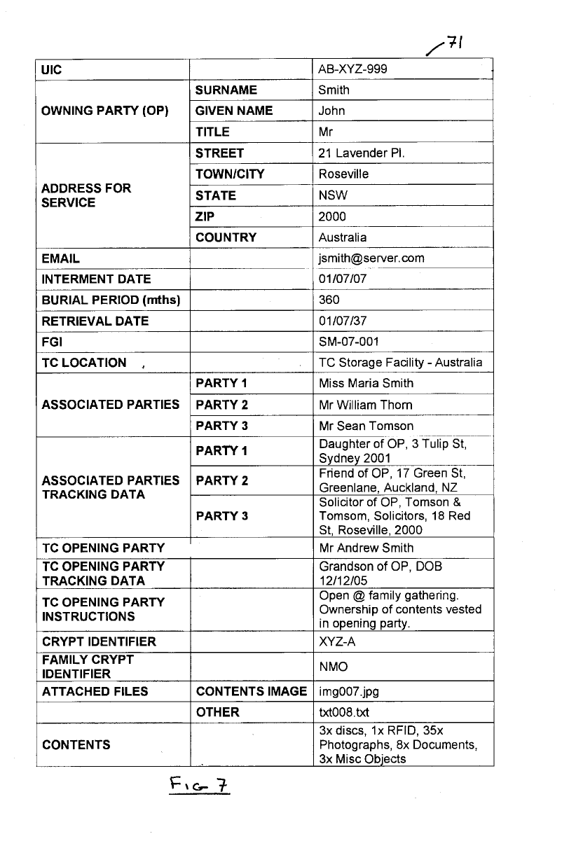

Still with reference to FIG. 4 and in particular a typical crypt 28 a preferred form of the said crypt is a cavity formed within a solid by means of casting a binding and protective substance around either a removable or sacrificial tube. Said tube can be of any cross section that suits the purpose and is not confined to a cylindrical cross section as shown. Indeed for the storage of rectangular shaped time capsules the use of rectangular tubes would be more appropriate. By way of non limiting example a crypt could be formed by casting concrete around a steel tube. Clearly there are numerous examples of suitable casting and tube materials. Similarly a preferred crypt module comprises an array of said tubes cast within a block such as is illustrated by the crypt module 31 in FIG. 4. Referring now to FIG. 8, a cross section of a crypt cast into a crypt module (where the double curved line indicates that the drawing has been shortened to better detail the ends) in a particularly preferred form of this embodiment the said crypt module comprises an array of metal tubes, one of which is shown as 64, closed at one end 69 and welded or otherwise fused 67 into a compatible metal plate 63 at the open end in the manner of a typical tube and tube-sheet construction of a tubular heat exchanger. The plate forms one side of the crypt module and the said casting material 66 is poured around the tube array to form a solid crypt module and the opposite surface of the said crypt module 70. The removable cover 30 is fixed in place by means of screws 65 and seals by means of O-ring or gasket 68 with the plate 63, thereby creating a sealed crypt in which to store the time capsule (not shown).

Still with reference to FIG. 8 the protective substance 66 cast around the tubular crypts is a substance that imparts solidity and strength to the crypt module and provides protection against impact, fire, smoke, water and similar threats to the said crypts and thereby the enclosed time capsules. Concrete and mortar have the advantage of being effective and inexpensive however they have the disadvantage of being very dense thereby making the said crypt modules heavy and difficult to move and stack. A preferred substance is less dense, aerated concrete such as AAC (aerated autoclaved concrete).

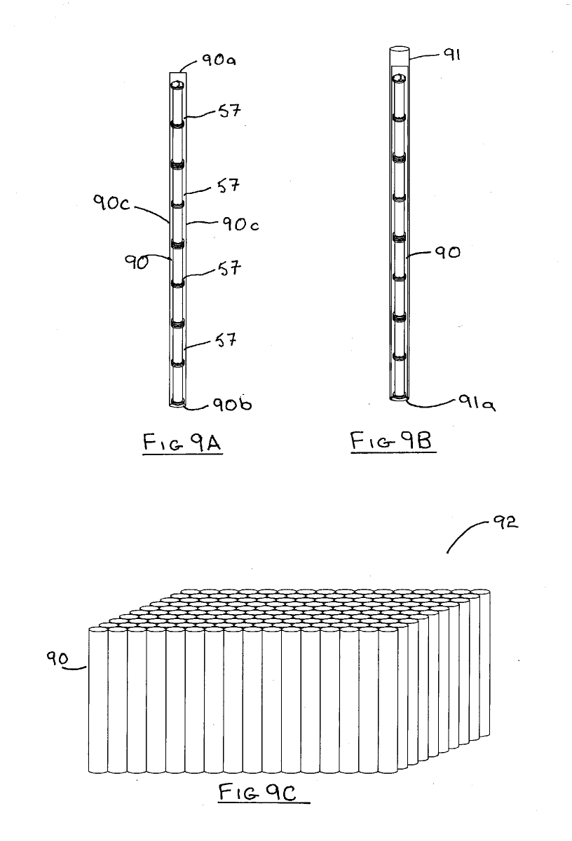

Another preferred form of storage system is shown in FIGS. 9A, 9B and 9C. A plurality of time capsules (in this case 4) 57 are stacked vertically in a stirrup arrangement 90. Said stirrup arrangement is a framework with a base 90b connected to a lifting point 90a by side frames 90c. Said stirrup containing time capsules 57 is lifted as a unit and lowered into a vertical elongated cavity such as a pipe 91 with a closed bottom end 91a. Said cavity can be closed off and sealed by a suitable cap arrangement (not shown). Each vertical cavity forms a crypt. A plurality of said cavities is arranged in an array 92. In this case the array shown is 10×16 making 160 cavities in total. The array is held together by a suitable framework (not shown). In such a manner very high time capsule storage densities can be achieved whilst maintaining easy access to every crypt. In a further preferred embodiment the said array of vertical cavities is buried partially or fully below ground level (not shown).

Referring now to FIGS. 1, 2 & 3 the controlling organisation 1 is an entity of a form that imparts confidence to the general public 20 in its stability and longevity. The said controlling organisation must manage and safeguard the integrity of the registry system 47 and the storage system 4 over a period extending far beyond the normal commercial horizon. The said controlling organisation must ensure that the data records pertaining to the time capsules in the time capsule registry system are available to the owning parties during the burial period. The said controlling organisation must ensure that the time capsules within its safekeeping are left undisturbed and protected against all common threats during their burial periods in order that the time capsules are available to their respective owning parties at the end of the burial periods. An essential obligation of the said controlling organisation is to ensure that sufficient financial reserves are retained by the said controlling organisation. Additionally, the controlling organisation must maintain an efficient collection and delivery system. Vacant time capsules must be delivered to owning parties, filled time capsules must be collected from the owning parties and time capsules must be delivered to the opening parties at the expiration of the burial period.

A preferred form of controlling organisation is a trust with a trust deed that aligns the obligations of the trustees with the obligations of the controlling organisation as outlined above. More preferably the trustee of the said trust is a corporate body. More preferably still the said corporate manages the said trust and also manages all of the functions of the said controlling organisation. In this case the said controlling organisation comprises the trust and the said corporate trustee collectively.

In a preferred embodiment of the invention the said controlling organisation has a significant representation from a parcel delivery organisation such as a postal or courier service. By way of non limiting example the corporate trustee referred to in the paragraph above might be a joint venture with a postal or courier service.

In a further preferred embodiment of the invention the said controlling organisation has representation from a public body as defined herein with a reputation for long term stability such as “The Public Trustee”.

In yet a further preferred embodiment of the invention the controlling organisation licenses agents to promote and manage the commercial activities of the controlling organisation in an at least one particular geographical area and/or commercial sector. Said agent would benefit from access to the assets and services of the controlling organisation whilst being free to concentrate on the promotion of the time capsule safekeeping service within its particular sector.

In Use

In use the system herein described allows for the safekeeping of time capsules by means of the proactive assignment of a UIC, the issuing of identifying devices, the utilisation of a registry system and a secure storage system for the said time capsules. By using the said safekeeping system herein described the existing impediments to the widespread and common use of time capsules by the general public are overcome.

The above describes only some of the present invention and modifications, obvious to those skilled in the art, can be made thereto without departing from the scope and spirit of the present invention.

What is claimed is:

1. A time capsule safekeeping system available for use by the general public (as defined herein) through a controlling organisation comprising in combination:
(a) an at least one centralised storage facility for a plurality of physical time capsules and
(b) a secure registry system for the recording and indexing of data records (as defined herein) related to said plurality of physical time capsules and
(c) an at least one type of identifying device supplied by the controlling organisation to at least the owning party or an associated party that at least provides a means of accessing the data record for said time capsule and prima facie proves ownership of the time capsule and
wherein
(i) said time capsules are physically stored in an indexed and recorded location by said controlling organisation in said at least one centralised storage facility such that they are provided with protection from common threats,
(ii) each said time capsule is proactively assigned a UIC by said controlling organisation and wherein said UIC is recorded on, in or with said time capsule,
(iii) the component data records of the database within said registry system includes, for each time capsule, data of at least said UIC and of the owning party of the time capsule together with additional data pertaining to each time capsule,
and wherein the database of said registry system is accessible by at least the owning party.

2. The safekeeping system of claim 1 wherein said time capsules are supplied by said controlling organisation as vacant time capsules to be filled and stored.

3. The safekeeping system of claim 2 wherein said supplied vacant time capsules are supplied with said UIC engraved or otherwise indelibly marked on at least one of the components of said vacant time capsule.

4. The safekeeping system of claim 2 wherein said supplied vacant time capsules are modular in form and wherein the components of said time capsules can be lower cost, mass produced standard components such as injection moulded plastic components and wherein said components are locked together on assembly such that time capsules of many varying dimensions can be made from a few standard components that securely fit together to form a totally gas and liquid tight container after assembly and closure and wherein the assembled time capsules are of dimensions compatible with said storage system.

5. The safekeeping system of claim 2 wherein said time capsule incorporates a fitting to facilitate the evacuation of air and/or the replacement of that air by a suitable inert fluid within said time capsule and the subsequent sealing of said time capsule, said fitting consisting of a captured elastomeric ring or plug designed to pass a sharp, smooth and hollow needle into the enclosure of said time capsule through which said evacuation and/or the replacement of the air can be effected such that said ring or plug seals as the needle is withdrawn and wherein an additional sealing device is fitted in place over the top of said elastomeric ring or plug after said evacuation and/or the replacement of the air has been effected such as a sealed plug screwed in place.

6. The safekeeping system of claim 2 wherein said vacant time capsules are supplied with packaging items designed to assist with the maintenance of an optimum storage environment within the time capsule such as porous sachets or capsules containing substances (such as silica gel) that adsorb or absorb gases that are likely to have a deleterious effect on the contents of the time capsule; neutral pH paper for interleaving of photographs and cushioning items for fragile articles.

7. The safekeeping system of claim 2 wherein said controlling organisation supplies or facilitates the supply of various memento type items to be stored within said vacant time capsules.

8. The safekeeping system of claim 7 wherein said various memento type items include any of the following:
(i) bottles of alcoholic liquor such as wine,
(ii) clockwork powered audio storage and playing devices such as MP3 players,
(iii) clockwork powered video storage and playing devices such as MP4 players,
(iv) newspapers and similar publications,
(v) digitally stored media content such as television programs and particularly news broadcasts.

9. The safe keeping system of claim 2 wherein said time capsules are provided with a tamper evident physical seal that must be broken before said time capsule can be opened, said seal being coded electronically and/or visually such that it is uniquely identified with a particular time capsule.

10. The safekeeping system of claim 9 wherein said tamper evident seals also act as identifying devices providing identifying data for the time capsule and/or access to the database of the registry system.

11. The safekeeping system of claim 1 wherein said data records of said database of said registry system can be searched and sorted by any data field.

12. The safekeeping system of claim 1 wherein said data record for each said time capsule includes any one of, or combination of, or all of the following data fields in addition to said UIC associated with each said time capsule:
(i) identification of the owning party of said time capsule at the time of burial,
(ii) tracking data for said time capsule owning party,
(iii) identification of the opening party of said time capsule at the time of burial,
(iv) tracking data for said time capsule opening party,
(v) the physical address for service of documents and communications,
(vi) the electronic address of owning party,
(vii) the burial period of the time capsule,
(viii) the interment date of the time capsule,
(ix) the retrieval date of the time capsule,
(x) the family group identifier,
(xi) the location of said time capsule at the time of said burial,
(xii) the contents of said time capsule,
(xiii) identification of any associated parties of said time capsule at the time of burial,
(xiv) tracking data for said time capsule associated parties,
(xv) instructions to said time capsule opening party,
(xvi) a visual image (digital or otherwise) of the contents of the time capsule at the time that it was filled and sealed,
(xvii) the crypt identifier if applicable.

13. The safekeeping system of claim 1 wherein said registry system allows a plurality of data records relating to a plurality of physical time capsules to be grouped as a family group.

14. The safekeeping system of claim 1 wherein said registry system is a computer based, interactive system configured for use with the internet.

15. The safekeeping system of claim 14 wherein at least the owning party can attain access to the data records including family groups of data records pertaining to their time capsules after satisfying security requirements by means of a pass-key issued by said controlling organisation and wherein alterations, deletions and additions to certain of said data fields of said data records can be made in order to maintain the currency and accuracy of the data held within said data records.

16. The safekeeping system of claim 1 wherein a copy or a plurality of copies of the data record, preferably as a compact electronic record, relating to a time capsule at the time of burial is/are enclosed within said time capsule.

17. The safekeeping system of claim 1 wherein said secure storage facility provides for the storage of said time capsules within an at least one crypt, said crypts providing protection for said time capsules such that the time capsules themselves need not be manufactured to be as robust as would otherwise be the case.

18. The safekeeping system of claim 17 wherein said crypts are specifically sized to accept modular time capsules or a plurality of modular time capsules supplied by the controlling organisation.

19. The safekeeping system of claim 17 wherein each said crypt has assigned to it a unique crypt identifier.

20. The safekeeping system of claim 17 wherein an at least one said crypt or plurality of crypts comprises a family crypt that provides for the burial of a family group of time capsules and wherein said family crypt has assigned to it a unique family crypt identifier.

21. The safekeeping system of claim 20 wherein said family crypt provides for each family member time capsule of said family group of time capsules to be buried and retrieved from burial at different times.

22. The safekeeping system of claim 17 wherein each said crypt comprises a cavity within a crypt module containing a plurality of such said cavities and wherein each said cavity is provided with a removable access cover such that when said access cover is fixed in place said cavity becomes totally enclosed and preferably sealed against ingress of liquid or gas.

23. The safekeeping system of claim 22 wherein said crypt module is formed by means of casting a binding and protective substance around a plurality of solid tubes such that the resulting said crypt module is a self contained solid block-like object containing a plurality of crypts that provides protection for the component crypts.

24. The safekeeping system of claim 22 wherein said crypts are easily removed and replaced from said crypt module for the purposes of adding or retrieving time capsules.

25. The safekeeping system of claim 22 wherein said crypt module is constructed with inbuilt features that facilitate the fixing of a plurality of said crypt modules together such that they lock together in both the horizontal and vertical planes to form a solid and robust assembly.

26. The safekeeping system of claim 25 wherein said assembly of crypt modules can be moved such that a plurality of such assemblies can be compressed up against one another to form a solid block-like structure in order to maximise the crypt storage capacity whilst offering superior protection to the component crypts.

27. The safekeeping system of claim 17 wherein said crypts are formed as an array of vertical cavities such as pipes designed to store time capsules in a vertical stack.

28. The safekeeping system of claim 27 wherein said vertical cavities are buried partially or fully beneath ground level.

29. The safekeeping system of claim 1 wherein said controlling organisation or representative thereof inspects the time capsule and its contents by visual or penetrative means such as X-ray to assist in ensuring no prohibited substances or items are included.

30. The safekeeping system of claim 1 wherein said identifying device takes the form of an engraved plaque or similarly permanently marked device that is easily recognised and not easily mislaid or discarded.

31. The safekeeping system of claim 1 wherein said identifying device has a machine readable code on it such as a one or two dimensional bar code or takes the form of or has within it an electronic identifying device as defined herein.

32. The safekeeping system of claim 31 wherein automated access to the corresponding data record within the registry system database is provided when said identifying device is scanned.

33. The safekeeping system of claim 1 wherein said controlling organisation provides at least said owning party with a plurality of said identifying devices of differing types.

34. The safekeeping system of claim 1 wherein said controlling organisation is a trust.

35. The safekeeping system of claim 34 wherein the trustee of said trust is a corporate body.

36. The safekeeping system of claim 1 wherein said controlling organisation has a significant representation from a parcel delivery organisation such as a postal or courier service.

37. The safekeeping system of claim 1 wherein said controlling organisation has representation from a public body as defined herein with a reputation for long term stability such as “The Public Trustee”.

38. The safekeeping system of claim 1 wherein said controlling organisation licenses agents to promote and manage the commercial activities of the controlling organisation in an at least one particular geographical area and/or commercial sector.

39. A method for the safekeeping of time capsules administered by a controlling organisation; said method including the step of proactively assigning a UIC to said time capsule and providing an identifying device for said time capsule and accepting for secure storage the time capsule and its contents and providing secure storage on behalf of the owner of said time capsule in a protected environment such as within a crypt herein described for the burial period of said time capsule and further including any of or combination of the following steps:
(a) recording data pertaining to said time capsule in a registry system,
(b) allowing limited access to the registry system by the general public,
(c) allowing complete access to data records pertaining to specific time capsules by the owning party or associated entities by means of a pass-key issued by said controlling organisation,
(d) supplying vacant time capsules from a standard range of said vacant time capsules to the owning party,
(e) supplying an at least one identifying device to the owning party,
(f) inspecting the time capsule and its contents by visual or penetrative means such as X ray,
(g) advising the owning party and/or associated parties when a time capsule is approaching the end of its burial period.
